(19) United States
(12) Patent Application Publication
(10) Pub. No.: US 2024/0412293 A1
(43) Pub. Date: Dec. 12, 2024

(54) CRYPTOGRAPHIC PROOF OF LIABILITY

(71) Applicant: International Business Machines Corporation, Armonk, NY (US)

(72) Inventors: Francesca M. Falzon, Metuchen, NJ (US); Kaoutar El Khiyaoui, Zurich (CH); Angelo De Caro, Zurich (CH); Elli Androulaki, Zurich (CH); Yacov Manevich, Beer Sheva (IL)

(21) Appl. No.: 18/208,463

(22) Filed: Jun. 12, 2023

(51) Int. Cl. G06Q 40/08; H04L 9/32

(52) U.S. Cl. CPC G06Q 40/08; H04L 9/3218; H04L 9/3236

(57) ABSTRACT

A tree data structure having a root node, internal nodes and leaf nodes can be generated. A liability to a user can be mapped to a leaf node of the tree data structure, where each internal node of the tree data structure contains vector commitments to its child nodes and the root node contains a commitment to a sum of all leaf nodes in the tree. Responsive to receiving a query, an authentication path along the tree data structure and a plurality of proofs that prove that sums of terms in vectors along the authentication path are correct, that each entry in the vectors along the authentication path is positive, and that a sum associated with a vector in each node along the authentication path is an entry in a parent node's vector, can be generated.

### BACKGROUND

The present application relates generally to computers and computer applications, and more particularly to cryptographic proof of liability (PoL) and data structure for the POL.

Proof of liabilities (PoL) is a mechanism that allows a prover (e.g., an exchange) to prove its liability to a verifier (e.g., a customer). Such proofs can aid in enforcing customer protections and capital requirements in decentralized ecosystems. For example, fund holding institutions should be able to guarantee that users can redeem their funds at any time, for example, without actually withdrawing it. Cryptographic proof of liabilities is a cryptographic primitive, for example, used in blockchain systems, which can provide such proofs.

Computer implemented data structures utilized in PoL or cryptographic PoL schemes may not be fully preserve-privacy and also may involve long proofs, which take longer time to run on a computer processor. For example, schemes that rely on binary trees, which are limited by their 2-ary structure may result in impractically long proofs. Those that may provide shorter proofs, may result in not being able to hide certain information such as the number of users.

### BRIEF SUMMARY

The summary of the disclosure is given to aid understanding of a computer system and method of proof of liability, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A computer-implemented method, in an aspect, can include generating a tree data structure having a root node, internal nodes and leaf nodes, wherein the tree data structure is a sparse n-ary tree having depth d. The method can also include, for each user in a set of users, mapping a liability to a user to a leaf node of the tree data structure, where each internal node of the tree data structure contains vector commitments to its child nodes and the root node contains a commitment to a sum of all leaf nodes in the tree. The method can further include, receiving a query from a requesting device associated with a user in the set of users, that a liability to the user is included in a total liability of a prover. The method can also include, responsive to receiving the query, generating an authentication path along the tree data structure and a plurality of proofs that prove that sums of terms in vectors along the authentication path are correct, that each entry in the vectors along the authentication path is positive, and that a sum associated with a vector in each node along the authentication path is an entry in a parent node's vector. The method can further include providing the authentication path and the plurality of proofs over a communications network to the requesting device.

A system, in an aspect, can include at least one processor. The system can also include at least one memory device coupled to the at least one processor. The at least one processor can be configured to generate a tree data structure having a root node, internal nodes and leaf nodes, where the tree data structure is a sparse n-ary tree having depth d. The at least one processor can also be configured to, for each user in a set of users, map a liability to a user to a leaf node of the tree data structure, where each internal node of the tree data structure contains vector commitments to its child nodes and the root node contains a commitment to a sum of all leaf nodes in the tree. The at least one processor can also be configured to receive a query from a requesting device associated with a user in the set of users, that a liability to the user is included in a total liability of a prover. The at least one processor can also be configured to, responsive to receiving the query, generate an authentication path along the tree data structure and a plurality of proofs that prove that sums of terms in vectors along the authentication path are correct, that each entry in the vectors along the authentication path is positive, and that a sum associated with a vector in each node along the authentication path is an entry in a parent node's vector. The at least one processor can also be configured to provide the authentication path and the plurality of proofs over a communications network to the requesting device.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement proof of liability in an embodiment.

FIG. 2 is a diagram that illustrates an example Verkle tree in an embodiment.

FIG. 3 is a diagram that illustrates an example of a sparse summation Verkle tree in an embodiment.

FIGS. 4A-4D illustrate SSVT in PoL application in an embodiment.

FIG. 5 shows another example of a sparse summation Verkle tree that can be generated in an embodiment.

FIG. 6 is a flow diagram illustrating a method of cryptographic proof of liability in an embodiment.

FIG. 7 is a diagram showing components of a system in one embodiment that can provide cryptographic proof of liabilities scheme.

### DETAILED DESCRIPTION

A computer-implemented method, in an aspect, can include generating a tree data structure having a root node, internal nodes and leaf nodes, wherein the tree data structure is a sparse n-ary tree having depth d. The method can also include, for each user in a set of users, mapping a liability to a user to a leaf node of the tree data structure, where each internal node of the tree data structure contains vector commitments to its child nodes and the root node contains a commitment to a sum of all leaf nodes in the tree. The method can further include, receiving a query from a requesting device associated with a user in the set of users, that a liability to the user is included in a total liability of a prover. The method can also include, responsive to receiving the query, generating an authentication path along the tree data structure and a plurality of proofs that prove that sums of terms in vectors along the authentication path are correct, that each entry in the vectors along the authentication path is positive, and that a sum associated with a vector in each node along the authentication path is an entry in a parent node's vector. The method can further include providing the authentication path and the plurality of proofs over a communications network to the requesting device.

Advantageously, the sparse n-ary tree data structure can allow for relatively short authentication path for proof of liabilities, and thus less nodes in the path which are stored, providing for savings and efficiency in computer storage and communication network bandwidth.

One or more of the following features can be separable or optional from each other. For example, at each internal node at depth d−1, V is a vector commitment of liabilities of the leaf nodes and a sum of the liabilities. Such structure can benefit from preserving the security of information transmitted over a communication network, for example, minimizing leakage of information.

In another aspect, each internal node at depth d−2 and lower can include two vector commitments <V, W>. An internal node can compactly and securely store information about its child nodes, saving computer storage space and preserving security of information.

Yet in another aspect, at each internal node at depth i∈[d−2], V can commit to (v₀, . . . ,vₙ) where for all j∈[n], vⱼ is a sum of values committed in a V component of a j^{th} child node, and vₙ is a sum of values (v₀, . . . ,vₙ₋₁). In this way, for example, information can be compactly stored in a parent node about its child node, saving storage space in computer storage.

Still yet in another aspect, W can commit to (w₀, . . . , wₙ₋₁) where for all j∈[n], wⱼ is a hash of a content of a j^{th} child node. Advantageously, the information transmitted can be further secured.

Yet in another aspect, the root node can commit to vector (v₀, . . . , vₙ), vₙ being a sum of all values stored in non-empty leaf nodes of the tree data structure. In this way, the root node can compactly store information about its non-empty leaf nodes, providing efficient computer storage when saving the root node.

In another aspect, the method can further include batching the plurality of proofs along the authentication path. In this way, for example, computer processing can be optimized, allowing a computer processor to perform the proof of liabilities computations more efficiently.

A system including at least one computer processor and at least one memory device coupled with the at least one computer processor can be provided, where the at least one computer processor can be configured to perform the method described above. A computer program product that includes a computer readable storage medium having program instructions embodied therewith, the program instructions readable by a device to cause the device to perform the above-described method can also be provided.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se. such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation or garbage collection, but this does not render the storage device as transitory because the data is not transitory while it is stored.

Computing environment 100 contains an example of an environment for the execution of at least some of the computer code involved in performing the inventive methods, such as proof of liability algorithm code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111. volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

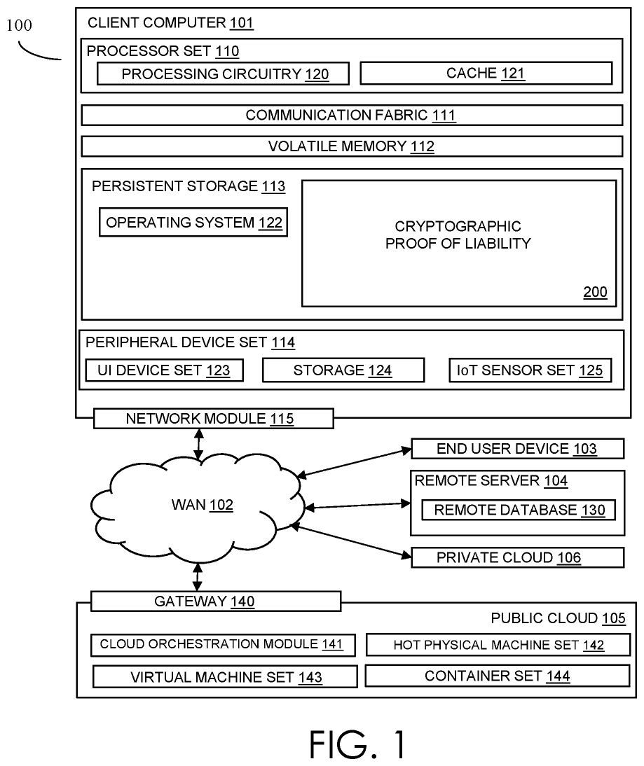

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In one or more embodiments, methods, systems, and/or techniques for proof of liability (also referred to as cryptographic proof of liability), for example, in connection with one or more databases (DBs) are presented. A technique, for example, uses data structure referred to as sparse summation Verkle trees and also uses tailored zero-knowledge proofs that reduce the size of the proof of liabilities. Briefly, a zero-knowledge proof or argument is a proof or argument that reveals nothing but its own validity. Aggregation methods can reduce the cost of the proof generation and verification. Sparse summation Verkle trees data structure can minimize information leakage, hide the number of users, and enable optimization through the batching of proofs. The use of sparse summation Verkle trees enables the technique to fully preserve the privacy of the users and the prover while reducing the size of the proofs of liabilities. Additionally, short proofs of liabilities are useful as they reduce communication and storage costs. Using the technique, a prover can show to a user that their liabilities are accounted for. In an embodiment, the individual liabilities need not be stored in the blockchain. Instead, in an embodiment, only an obfuscated representation of the total liabilities can be published to the blockchain, against which users verify the proofs they receive. Proofs of liabilities enable accurate accounting of the liabilities of entities such as financial institutions if the majority of the customers participate. Fully privacy-preserving proofs of liabilities ensure that the information of a user and also the number of users do not leak to third parties. For example, using sparse summation Verkle trees ensures that even an upper bound of the number of users cannot be inferred. Using sparse summation Verkle trees one can commit to the liabilities of individual users and minimize the size of the proofs.

A public bulletin board (PBB) provides the same view to all entities (i.e., consensus). The PBB may be instantiated using a blockchain that one can read from or write to. The public data (PD) computed at setup is published in the PBB, ensuring thus, that all users in a set of users (e.g., U) have the same view of the public data PD.

Networking communication can be impacted by the proof length, which is usually logarithmic in state capacity. The sparse summation Verkle tree data structure and method, disclosed herein, for example, used as protocols in blockchain platforms or systems, can improve networking communications bandwidth. For instance, data transactions over a large array of communication networks, for example, such as crypto wallets or other transactions can be run efficiently on a computer.

In an aspect, a user verifying a proof of liability only learns whether their liability is included or not. For example, the technique also introduces compatible zero-knowledge proofs that ensure that a user verifying a proof of liability only learns whether their liability is included or not. The use of sparse summation Verkle trees enables the system and/or method to fully preserve the privacy of the users and the privacy of the prover while reducing the size of the proofs of liabilities. In one or more embodiments, methods, systems and/or techniques can provide for short or reduced size proofs while ensuring privacy to the users and minimizing leakage. Short proofs of liabilities are useful in contexts where communication and storage resources are scarce.

An example use case includes banking. An entity managing user's funds such as banking or financial institutions can provide a proof of solvency, e.g., that the total liabilities do not exceed its total assets, in order to assure the user of any risk related to the user's funds managed by the entity. In this way, the user can be allowed to verify that their funds can be redeemed without actually withdrawing it.

A proof of liability (PoL) is a cryptographic primitive that enables a prover to publish its total liabilities and then efficiently prove to each of its users that their corresponding liability is included in the published total. A proof of reserves (PoR) is a cryptographic primitive that enables a prover to prove that it possesses the assets that they claim. PoL and PoR together form a proof of solvency, a protocol that enables a prover to prove that its assets are at least as much as the liabilities it owes to its clients.

In an aspect, proof of liabilities (PoL), which is a cryptographic primitive, solves half of solvency auditing problem. Its goal is to prove the amount the audited entity owes to its clients. The other half of the solution is proof of reserves (PoR). Its goal is to prove to the clients that it has sufficient funds to cover their liabilities. Proof of liability enables clients to check that their liability is included in the total liability of its bank. The clients can then use proof of reserves to check that the bank's holdings are sufficient to cover the total liability.

For instance, a financial entity may prove to its customers and third party regulators that it has a claimed amount of financial liabilities to its customers, while preserving the privacy of the customers at the same time. This can be facilitated with the help of a data structure which is a sparse summation Verkle tree (SSVT). Using SSVT, it is possible to prove without leaking confidential information that each vertex in the tree is cryptographically bound to its direct ancestor, and also the direct ancestor's value is the sum of its descendants. The aforementioned proving technique is efficient because it allows to stitch many proofs together and then verify it more efficiently.

Other use cases can include proof of liability in other cases, publishing cases of diseases, and negative voting.

A technique using an SSVT can guarantee liabilities to users in a privacy-preserving manner and while supporting the aggregation of proofs along the authentication path. This work has applications in the context of retail CBDCs, since this will enable users to check their holdings and liabilities directly with the commercial bank, and check that the liabilities of the commercial bank are consistent with those published on the blockchain. The technique can also support data privacy.

The sparse summation Verkle tree (SSVT) data structure can be provided to accumulate liabilities, which can result in flatter trees and shorter authentication paths, and which can hide the total number of users, further mitigate leakage, and benefit from the efficiency of vector commitments.

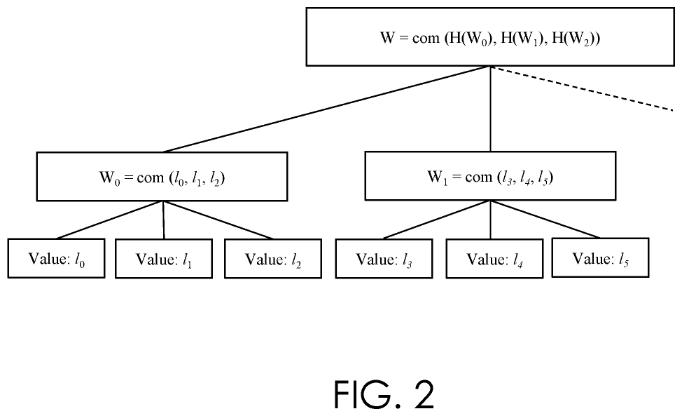

FIG. 2 is a diagram that illustrates an example Verkle tree. A Verkle tree is like a Merkle tree, but it replaces the hash values of the inner nodes with vector commitments. Each inner node is labeled with a commitment to an M-length vector. Each index of the vector corresponds to (the hash of) one of the M child nodes.

A vector commitment is a primitive that commits to an ordered sequence of values in such a way that one can selectively open a value at a given index concisely (i.e., using a constant-size proof). A vector commitment is hiding if it does not leak any information about the committed vector. A vector commitment scheme can be considered a special type of hash function, e.g., has of a list of values, h(vᵢ, v₂, . . . , vₙ)->C. Vector commitments have a property that for a commitment C and a value vᵢ, it is possible to make a short proof that C is the commitment to some list where the value at the ᵢ-th position is vᵢ.

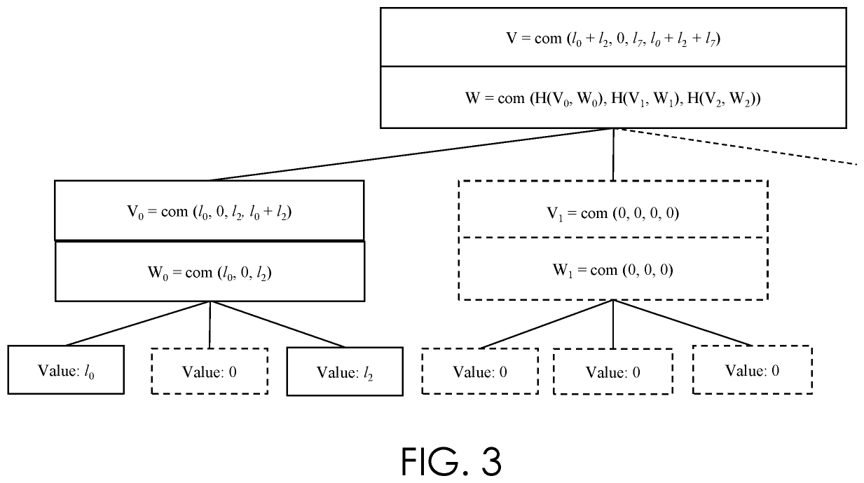

FIG. 3 is a diagram that illustrates an example of a sparse summation Verkle tree. A sparse summation Verkle tree (SSVT) over a set S is a summation Verkle tree whose leaves contain the elements in S. Most leaves in the SSVT are empty, so the tree can be represented compactly using only the necessary nodes. For example, the dashed boxes represent empty nodes.

Sparse Verkle trees are authenticated data structures, which can be of intractable size. Similar to sparse Merkle trees, sparse Verkle trees enjoy the property of history independence. That is, the order in which elements are inserted has no effect on the value of the root. A difference between a sparse Merkle tree and a sparse Verkle tree is that an internal node in the latter is computed as a vector commitment to its children (child nodes).

By construction, vector commitments result in constant proofs of inclusion. That is, the proof Ω that a value v opens a vector commitment V at index i does not depend on the size of the committed vector. Consequently, authentication paths in a sparse Verkle tree only grow with depth d of the tree; Namely, an authentication path consists of d tuples (vᵢ, Ωᵢ, Vᵢ₋₁), 1≤i≤d.

Applying the SSVT to PoL, the leaves of the SSVT correspond to the universe of possible users. Users are assigned to leaves of the SSVT by hashing their identifiers (IDs). When a user queries for inclusion it receives the authentication path and a number of proofs ensuring that: The sum terms in the vectors along the authentication path are correct; Each entry in each of the vectors along the authentication path is positive; The sum associated with the vector of each node in the authentication path is an entry in the vector of the parent.

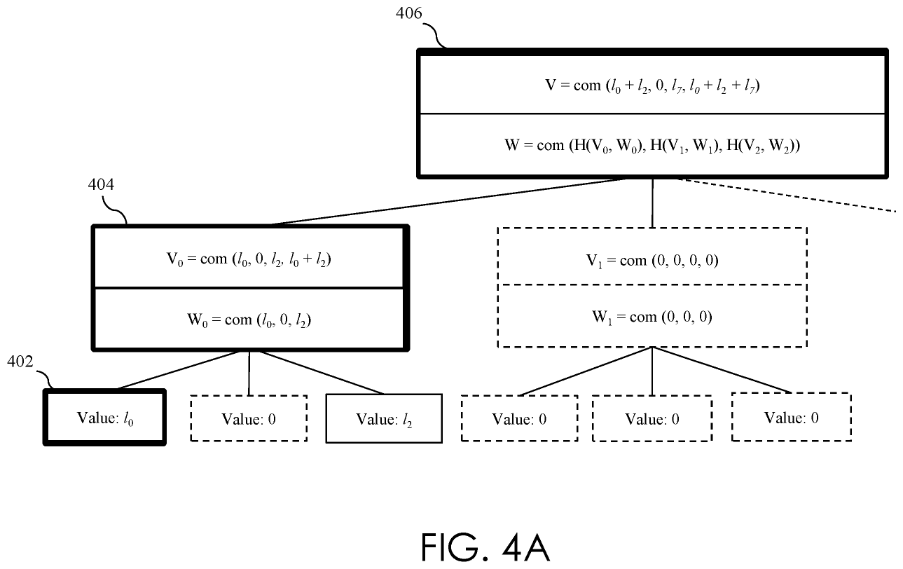

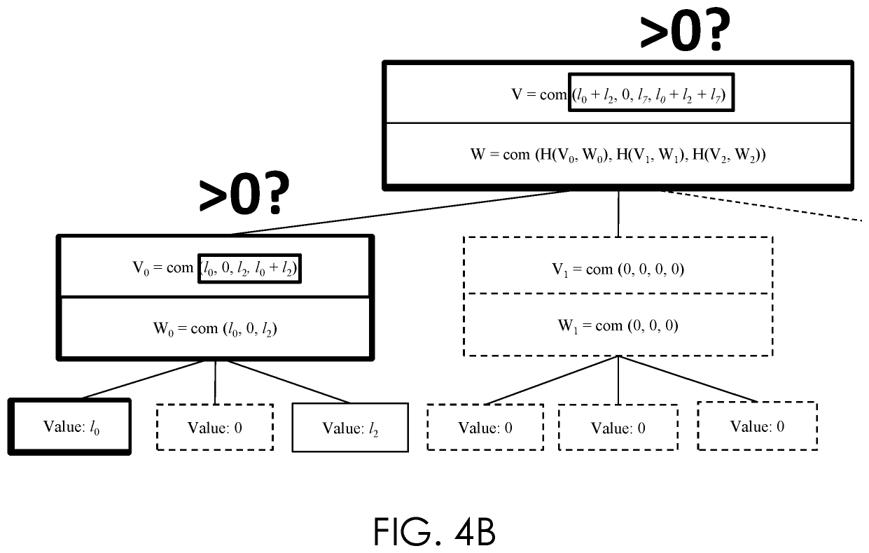

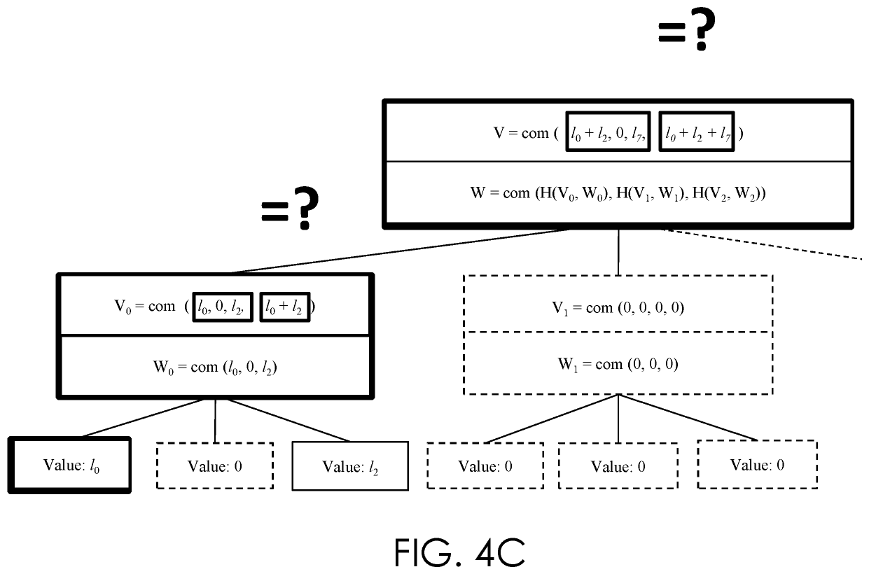

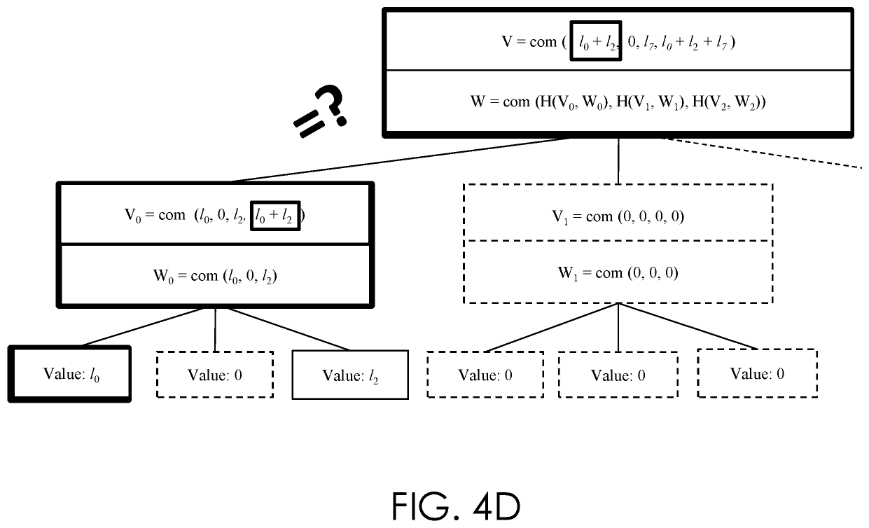

FIGS. 4A-4D illustrate SSVT in PoL application in an embodiment. Referring to FIG. 4A, if the user with ID id₀ queries for its liability, then the prover returns the authentication path. An example of the authentication path of SSVT that is returned can include nodes at 402, 404 and 408, e.g., node identifiers of those nodes. If the user with ID id₀ queries for its liability, then the prover returns the authentication path, together with some proofs. Referring to FIG. 4B, a range proof that all values in the vectors along the authentication path are positive can be provided. Referring to FIG. 4C, a sum argument that the M+1 term is the sum of the previous M entries of the vector can be provided. Referring to FIG. 4D, an opening equality argument that the sum of the child node is a term in the parent's vector can be provided.

The sparse Verkle tree data structure can be constructed as follows. Examples of the construction are shown in FIGS. 3 and 4A-4D. Let T_{n,d} be a sparse Verkle tree of ary n and depth d. The values of ary n and depth d can be given or can be configurable. The value of depth d can be chosen based on how long one would like the proof to be. By way of example, starting from the size of the universe that is being represented, d can be chosen, which determines the length of the proof, and then find n. Size of universe <=n\hat{ }d. For a PoL scheme, the technique or methodology in an embodiment maps the liability to each user to a leaf in T_{n,d}. and stores in each internal node two vector commitments (V, W). At depth d−1, Vis the vector commitment of the liabilities of the leaves and their sum while W is kept empty. At depth i∈[d−1] (i.e., i is in [0, . . . , d−2]), V commits to (v₀, . . . , vₙ) where for all j∈[n], vⱼ is the sum of the values committed in the V component of the j^{th} child, and vₙ is the sum of values (v₀, . . . , vₙ₋₁). W, on the other hand, commits to (w₀, . . . , wₙ₋₁) where for all j∈[n], wⱼ is the hash of the content of the j^{th} child. This construction corresponds to a summation Verkle tree: the V component of the root commits to vector (v₀, . . . ,vₙ) with vₙ being the sum of all the values stored in the non-empty leaves.

For privacy purposes, a method in an embodiment can use hiding vector commitments, which guarantee that accessing the content of the nodes on an authentication path does not leak information about the liabilities stored in the leaves. To ensure that the authentication paths are well formed without disclosing any information about the liabilities, the method can leverage zero-knowledge arguments.

Consider that the set of users are the parties who store their assets or funds with the organization. The prover P operates on behalf of the organization and is the entity liable to the users. The prover's goal is to prove to users that their P's liabilities to them are included in the total.

Let u be a user requesting a proof of liability and l its liability. Let ( [symbol] V_{d-1}, W_{d-1} [symbol] , . . . , [symbol] V₀, W₀ [symbol] ) be the content of the nodes from the leaf associated with u to the root (root included). [symbol] V_{d-1}, W_{d-1} [symbol] is the parent of the leaf and [symbol] V₀, W₀ [symbol] is the root of the tree.

Prover P's goal is to show that V_{d-1} commits to l at the expected index, and that the last element committed in V_{d-1} is the sum of all the children's liabilities. Recall that W_{d-1} is empty. Next, for all nodes at depth d−2≤i≤0, P should prove that (1) Wᵢ commits to the hash of [symbol] Vᵢ₊₁, Wᵢ₊₁ [symbol] ; (2) Vᵢ commits to the sum encoded in Vᵢ₊₁; (3) and the last element committed in Vᵢ is the sum of the previous elements in the vector.

Note that since (W₀, . . . , W_{d-1}) encode only public information, their respective proofs can be computed following the algorithms of the underlying vector commitment (i.e., no need for zero-knowledge arguments). In the case of (V₀, . . . , V_{d-1}), the method may include demonstrating in zero-knowledge that for all i∈[d−1]: (1) the last element of the vector committed in Vᵢ is the sum of the previous elements (sum argument over vector commitments); (2) the last element committed in Vᵢ₊₁ opens Vᵢ at a position determined by the index of the leaf storing l(opening equality argument over vector commitments).

In an embodiment, to prevent the prover from injecting negative values in the vector commitments and bringing its total liabilities down, the method uses range proofs (e.g., shown in FIG. 4B) to ensure that all the values committed in Vᵢ are in range [2^{m}], for some predefined value m.

In an aspect, plugging existing range proofs directly into the construction may incur O(dn log(m)) communication complexity. In an embodiment, a new range proof over vector commitments can be provided that lowers the communication cost from O(dn log(m)) to O(d log(nm)).

The method can further optimize the scheme through the aggregation of the opening equality arguments, the sum arguments, and the range proofs along the authentication path. Aggregating the opening equality arguments reduces the number of pairings performed during verification and the size of the proof. The aggregation of the sum arguments can also provide cost effectiveness in terms of size of proof and complexity. This decreases the size of the proof from O(d log (n)) to log(n) and the complexity of the proof generation and verification from O(dn) to O(d+n). The aggregation of the range proofs further lowers the communication cost of the range proofs from O(d log(nm)) to O(log(dnm)).

The method in an aspect can also provide for security and privacy guarantees. The soundness of the PoL scheme directly follows from the binding property of the vector commitments and the soundness of the opening equality and sum arguments and range proofs. Additionally, the hiding property of the vector commitments and the zero-knowledge property of the arguments guarantee the privacy of user liabilities. The history independence of the sparse Verkle tree ensures that the construction does not leak any information about the size of the prover's database.

The technique disclosed herein can support the black box use of any range protocol (FIG. 4B), sum argument (FIG. 4C), and opening equality argument (FIG. 4D) that takes as input Pedersen-like vector commitments. The scheme can be further enhanced by supporting the batching of proofs (e.g., the technique can batch the proofs along the authentication path and reduce communication and verification time).

FIG. 4B shows providing range proofs over vector commitments. Given a hiding vector commitment V, a range proof enables a prover to show in zero-knowledge that the elements of vector v committed to in V fall into a particular range. In an example PoL scheme, the method may show that 0≤v[i]<max, where max is an upper-bound of individual liabilities that a PoL prover can hold.

FIG. 4C illustrates providing a sum argument over vector commitments. Given a hiding vector commitment V, a sum argument is a zero-knowledge argument of knowledge that allows a prover to demonstrate that the last element of the vector committed in V is the sum of all the previous elements.

FIG. 4D illustrates providing an opening equality argument over vector commitments. An opening equality argument is a zero-knowledge argument of knowledge that allows a prover to show that two hiding vector commitments V and W open to the same value v at indices i and j respectively.

A technique, in an embodiment, stores the prover's liabilities in a sparse summation Verkle tree (SSVT), a tree in which each internal node is a hiding vector commitment of its children and whose root commits to the sum of all the leaves in the tree. The technique then leverages inner product arguments to prove that a liability of a user is included in the total liabilities of the prover without leaking any information beyond the liability's inclusion. The privacy of the scheme follows from the history independence of the SSVT, the zero-knowledge of the inner product arguments, and the hiding property of the vector commitments. Such construction yields proofs of size O(logₙ N) for trees of ary n and size N. Additionally, the technique can include further optimizing the proof size using aggregation.

In an aspect, using the SSVT, privacy can be provided for both the prover and verifiers. Sparse Summation Verkle Tree (SSVT) data structure can hide the number of users while shortening the authentication path. An SSVT is a modified sparse Merkle tree in which each internal node contains vector commitments to its children and whose root node contains a commitment to the values of the leaves of the tree, e.g., the sum of all the leaves in the tree. Briefly, a Merkle tree is a binary tree (2-ary structure) whose inner nodes contain a hash to their respective children. The SSVT can be of intractable size, yet it can still be represented compactly by only storing the nodes along the paths from leaf nodes of actual users to the root. SSVTs support ary n≥2, thus hiding the total number of users while ensuring short authentication paths.

By relying on vector commitments, the tree can have ary n≥2 and short inclusion proofs. In an aspect, the tree ary is inversely related to the proof size. The scheme also benefits from the short proofs and efficient openings of the vector commitments. The technique can combine the hiding vector commitments with inner product arguments to design tailored zero-knowledge proofs that allow for showing that the liability to a user is included in the tree in a privacy-preserving manner. The size of the resulting inclusion proofs can be further optimized using aggregation techniques.

The following notations can be used. Let [n] denote the set of integers {0,1, . . . , n−1} and [m . . . n] the set of integers {m, m+1, . . . , n−1}. For some set S, let x←$ S denote the random sampling of an element x from S.

Given a map M, the set of corresponding keys K, and a set S⊆K, M[S] denotes the restriction of M to S, i.e., the map with keys in S.

The description can take [symbol] to be a cyclic group of prime order p and [symbol] ₚ to be the ring of integers modulo p. Lower-case letters are reserved for elements in [symbol] ₚ, whereas upper-case letters denote elements in [symbol] . Let [symbol] ⁿ and [symbol] ₚⁿ be the vector spaces of dimension n over [symbol] and [symbol] ₚ, respectively. The description can denote vectors using bold font, e.g., v∈ [symbol] ₚⁿ represents an n-dimensional vector with elements in [symbol] ₚ.

Given a vector v=(v₀, . . . , vₙ₋₁)∈ [symbol] ₚⁿ, the description can use v[i] to denote the element at index i (i.e., v[i]=vᵢ), v[:m] to denote sub-vector (v₀, . . . , vₘ₋₁), and v[m:] to denote sub-vector (vₘ, . . . , vₙ₋₁) for integer m<n. More generally, for any ordered set S={i₁, . . . , iₘ}⊆[n], the description can denote by v[S], the sub-vector (vᵢ_{₁}, . . . , vᵢ_{ₘ}).

The same notation can be used to index vectors in [symbol] ⁿ.

Given vectors v and w of lengths n and m, respectively, the description can denote by v∥w the concatenation of vectors to form a new vector of length n+m. Given vectors v, w∈ [symbol] ₚⁿ, let v·w=Σᵢ₌₀ⁿ⁻¹vᵢwᵢ denote the inner product of v and w. For vectors G=(G₀, . . . , Gₙ₋₁)∈ [symbol] ⁿ and v=(v₀, . . . , vₙ₋₁)∈ [symbol] ₚⁿ, let G^{v}=Πi=0ⁿ⁻¹Gᵢ^{v}^{ᵢ}∈ [symbol] . Note that if for all i≠j, the discrete logarithm of Gᵢ relative to Gⱼ is unknown, then G^{v} is a binding Pedersen commitment to vector v.

An example implementation of a SSVT (referred to herein as a Verkle tree) in an embodiment is described as follows. As described above, T_{n,d} denotes a sparse Verkle tree of ary n and depth d. In an embodiment, each leaf of the Verkle tree can be labeled with identifiers. Any scheme for labeling can be utilized. An example scheme can be as follows. For example, the method may identify the vertices of T_{n,d} by their labels λ and the root by empty label ε. A leaf in the tree has label λ=λ₁ . . . λ_{d} such that ∀1≤i≤d, λi∈[n], and the path from the root to the leaf is determined by nodes with labels (ε, λ₁, λ₁λ₂, . . . , λ₁ . . . λ_{d}). Conversely, the children of an internal node with label λ are determined by labels λ∥i for i∈[n]. Accordingly, the method may refer to the child with label λ∥i, the child at index i of node λ. Let S be a subset of [n]^{d}. The method may denote by Tree(S) the labels of the union of all the paths from the leaves identified by S to the root ε, and by Frontier(S) the labels of the nodes that are not in T_{n,d} but their parent is.

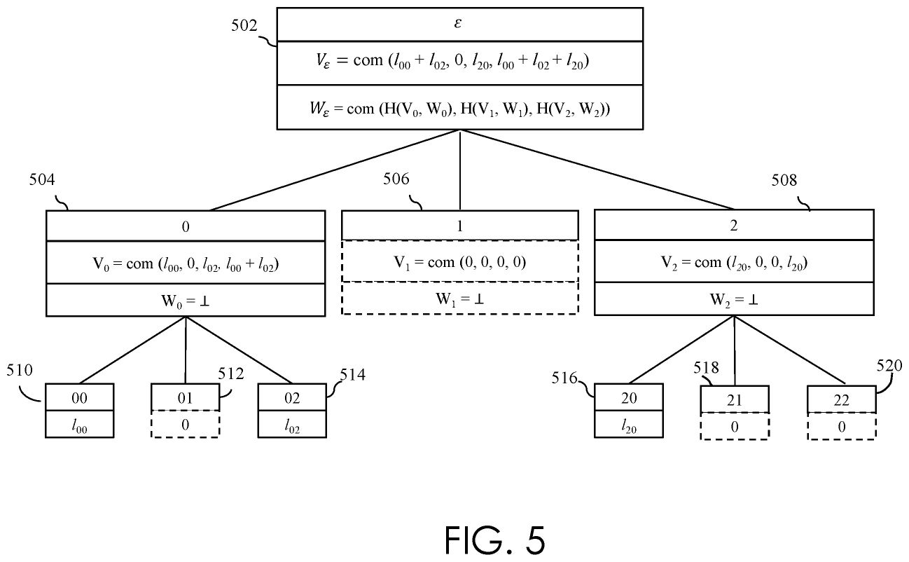

During setup, prover P builds a sparse summation Verkle tree (SSVT). This corresponds to a sparse Verkle tree T_{n,d}, in which a node at depth d (i.e., a leaf) stores a value in [symbol] ₚ, a node at depth d−1 stores a vector commitment V_{d-1} to the values in its children together with their sum, while an internal node at depth 0≤i≤d−2 stores two vector commitments [symbol] Vᵢ, Wᵢ [symbol] , where Vᵢ is a vector commitment to the sum value committed in each child plus their sum, and Wᵢ is a vector commitment to the hash of each child. FIG. 5 shows another example of a sparse summation Verkle tree that can be generated in an embodiment. A sparse Verkle tree T_{3,2} is shown such that S={00, 02, 20}⊆[3]². The nodes 502, 504, 508, 510, 514, 516 denote Tree(S), which corresponds to the paths from the root to the leaves identified with labels in S. The nodes 506, 512, 518, 520 denote Frontier(S) (i.e., padding nodes), which corresponds to nodes that are not in T_{3,2} but whose parents are. Nodes leading to the root are labeled with a value in [3], whereas a leaf is labeled with value in [3]². For example, the children leaves of node 0 shown at 504 are labeled 00, 01 and 02 (shown at 510, 512, 514). In an example implementation, in an embodiment, prover P computes for each entry (id, l)∈DB a label h(id) and appends the result to the set of labels S. P then computes padding nodes, which coincide with labels in Frontier(S). A leaf in Frontier(S) contains value 0, a node at depth d−1 contains a hiding vector commitment to a zero vector, whereas a node at depth d−2 or lower contains two hiding vector commitments to zero vectors.

Prover P computes non-empty nodes, which are determined by labels in Tree(S). A leaf in Tree(S) contains value l, such that (id, l)∈DB and h(id)∈S. A node at depth d−1 stores the commitment to a vector v=(v₀, . . . , vₙ) whereby vᵢ is the value of the child at index i for 1≤i≤n−1 and vₙ is the sum of these values (i.e., vₙ=Σᵢ₌₀ⁿ⁻¹vᵢ). A node at depth d-2 or lower stores two vector commitments. The first commitment commits to v=(v₀, . . . , vₙ), with, vₙ=Σᵢ₌₀ⁿ⁻¹vᵢ and vᵢ for 1≤i≤n−1 being the sum committed in the child at index i. The second commitment commits to the hash of the vector commitments in each child.

Setup concludes by outputting a pair (PD, SD), where PD= [symbol] V₀, W₀ [symbol] is the root of the sparse summation Verkle tree T_{n,d} and SD is the secret data to build T_{n,d}. That is, the values and the randomness used to compute the hiding vector commitments in T_{n,d}. Prover P then publishes PD to a public bulletin board via blockchain, while storing SD locally.

In proving total liabilities, given root PD= [symbol] V₀, W₀ [symbol] and secret data SD, prover P shows that its total liabilities equal L by opening V₀ at position n, and outputting the resulting proof Π.

For proving individual liabilities, when P receives a proof of liabilities request, it first authenticates it. If the request did not originate from a user u∈U, then prover P rejects. Let id be the identifier of the user. Prover P correspondingly, computes λ=λ₁ . . . λ_{d}=h(id), which identifies a unique path in T_{n,d}. Recall that T_{n,d}'s root stores (V₀, W₀). Without loss of generality, the method denotes by (Vᵢ, Wᵢ), 1≤i≤d−1, the content of the internal nodes along the path.

Now prover P generates: (a) a range proof Ψ₀ that demonstrates that the values committed in V₀ are in the authorized range; (b) a sum argument Φ₀ that proves that V₀ is a commitment to vector v₀ such that v₀[n]=Σᵢ₌₀ⁿ⁻¹v₀[i].

Then for each internal node, at depth 1≤i≤d−1, on the path from the root to λ, prover P: (a) shows that the hash of the content of the node opens commitment Wᵢ₋₁ at position λᵢ; (b) produces a range proof Ψᵢ that shows that the values committed in Vᵢ are in the authorized range; (c) computes a sum argument Φᵢ that proves that Vᵢ is a commitment to vector vᵢ such that vᵢ[n]=Σⱼ₌₀ⁿ⁻¹v₀[j]; (d) generates an opening equality argument that demonstrates that vᵢ[n] open Vᵢ and Vᵢ₋₁ at positions n and λᵢ respectively.

Finally, P opens vector commitment V_{d-1} at position λ_{d}. Let π denote all the proofs generated by prover P. Upon receiving P's response π, the user parses it as a d+1-length array [symbol] , where for 1≤i≤d, [symbol] [i] contains the proofs produced for the i^{th} node on the path from the root to leaf λ=h(id), and [symbol] [0] contains the proofs generated for the root. The user then reads [symbol] [0] as (Ψ₀, Φ₀) and checks whether they are valid range proof and sum argument with respect to the published vector commitment V₀. Next, the user parses [symbol] [i] for 1≤i≤d−1 as (Vᵢ, Wᵢ, Ψᵢ, Φᵢ, Υᵢ, Ωᵢ) and verifies whether: (a) Ωᵢ is a valid proof that opens vector commitment Wᵢ₋₁ to value h(Vᵢ, Wᵢ) at position λᵢ; (b) (Ψᵢ, Φᵢ) are valid range proof and sum argument with respect to vector commitment Vᵢ; (c) Υᵢ is a valid opening equality argument for vector commitments Vᵢ and Vᵢ₋₁ at positions n and λᵢ respectively. Finally, the user parses [symbol] [d] as Ω_{d} and checks if Ω_{d} proves that vector v_{d-1} committed in V_{d-1} satisfies v_{d-1}[λ_{d}]=l, where l is the liability of prover P to the user. If all checks succeed, then the user accepts the proof of liability; otherwise, it rejects.

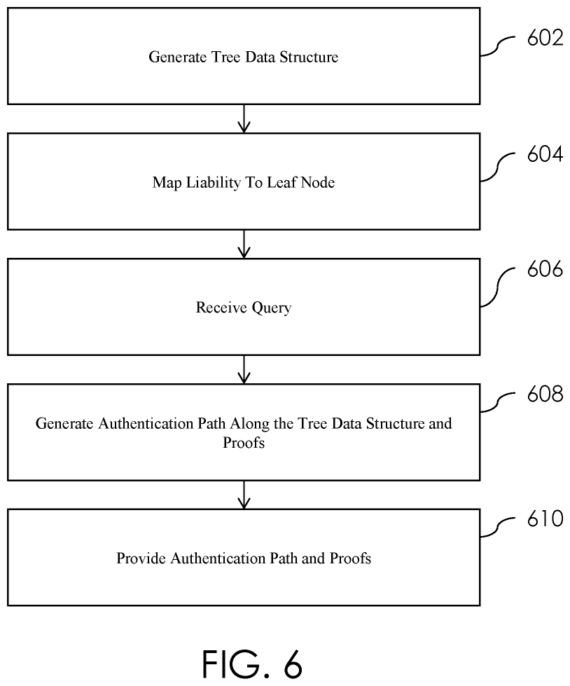

FIG. 6 is a flow diagram illustrating a method of cryptographic proof of liability in an embodiment. The method or acts described can be performed by one or more computers or computer processors in a computing environment, for example, including but not limited to, those described with reference to FIG. 1 above. At 602, the method can include generating a tree data structure having a root node, internal nodes and leaf nodes. The tree data structure is a sparse n-ary tree having depth d.

At 604, for each user in a set of users, the method can include mapping liability to a user to a leaf node of the tree data structure. For example, the liability to a user is a liability that a prover has to a user. Such liability can be mapped to a leaf node. Each internal node of the tree data structure contains vector commitments to its children and the root node contains a commitment to a sum of all leaf nodes in the tree. In each internal node at depth d−1, V can be a vector commitment of liabilities of the leaf nodes and a sum of the liabilities. The root node can commit to vector (v₀, . . . , vₙ), vₙ being a sum of all values stored in non-empty leaf nodes of the tree data structure.

Each internal node at depth d−2 and lower depth can include two vector commitments <V, W>. In each internal node at depth i∈[d−2], V can commit to (v₀, . . . , vₙ), where for all j∈[n], vⱼ is a sum of values committed in a V component of a j^{th} child node, and vₙ is a sum of values (v₀, . . . ,vₙ₋₁). W can commit to (w₀, . . . , wₙ₋₁), where for all j∈[n], wⱼ is a hash of a content of a j^{th} child node.

At 606, the method can include receiving a query from a requesting device associated with a user in the set of users, that a liability to the user is included in a total liability of a prover. For example, the query asks the prover to prove that a liability owed to the querying user is included in the total liability that the prover is responsible for.

At 608, the method can include, responsive to receiving the query, generating an authentication path along the tree data structure and a plurality of proofs. The authentication path includes nodes of the tree data structure from the leaf node that represents the querying user liability to the root node of the tree data structure. The plurality of proofs includes proofs that prove that sums of terms in vectors along the authentication path are correct, that each entry in the vectors along the authentication path is positive, and that a sum associated with a vector in each node along the authentication path is an entry in a parent node's vector.

At 610, the method can include providing the authentication path and the plurality of proofs over a communications network to the requesting device. The method can also include batching the plurality of proofs along the authentication path.

In another aspect, a system for cryptographic proof of liability in an embodiment can include one or more processors such as computer processors, e.g., running in a computing environment shown in FIG. 1. One or more processors can be configured to perform the acts or methods described with reference to FIG. 6.

Cryptographic proof of liability described herein can be secure and privacy-preserving. In an aspect, in the cryptographic proof of liability implemented using a sparse Verkle tree described here, an adversary does not learn the size of the prover's database DB. The following illustrates additional details of cryptographic proof of liability in one or more embodiments, e.g., the hiding vector commitments introduced, and tailor-made range proofs, opening equality arguments and sum arguments. Together, these primitives can keep the proofs of liabilities short.

### Inner Product Argument

To construct the sum argument and range proof, inner product arguments can be leveraged. These enable a prover to show that the inner product of two vectors v, w∈ [symbol] ₚⁿ committed to using Pedersen vector commitments evaluates to a public value c.

Definition. Let G=(G₀, . . . , Gₙ₋₁) and H=(H₀, . . . Hₙ₋₁) be two vectors of n generators of [symbol] , such that for all i≠j, the relative discrete log of Gᵢ (resp. Hᵢ) relative to Gⱼ (resp. Hⱼ) is unknown.

An inner product argument IPA=( [symbol] _{IPA}, [symbol] _{IPA}, [symbol] _{IPA}) is an argument of knowledge for the following relation:

$$x = ( P , c ) ; w = ( a , b ) ∈ {ℤ}_{p}^{n} \times {ℤ}_{p}^{n} : P = {G}^{a} {H}^{b} ∧ a \cdot b = c$$

In an embodiment, a method implemented by a processor can instantiate the inner product argument using the improved inner product argument. This argument can be made non-interactive using the Fiat-Shamir heuristic.

### Hiding Vector Commitments

A method implemented by a processor can instantiate the hiding vector commitments with Pointproofs. This scheme extends the pairing-based vector commitment to support the aggregation of openings across the same commitment as well as different commitments. This reduces the cost of verification (notably, the number of pairings to be computed). A method implemented by a processor can also leverage the aggregation of openings to aggregate opening equality arguments.

Let ( [symbol] , [symbol] _{T}) be groups of prime order p that admit an efficient bilinear pairing e: [symbol] × [symbol] → [symbol] _{T}. Let G and e (G, G) be generators of [symbol] and [symbol] _{T}, respectively. Pointproofs uses asymmetric pairings. For ease of exposition, the scheme using symmetric pairings is described. Pointproofs comprises of 8 algorithms.
1. pp_{VC}←ParamGen(1^{κ}, n): Sample α←$ [symbol] ₚ and output G and

$$F = ( {F}_{0} , … , {F}_{n} , {F}_{n + 2} , … , {F}_{2 n + 1} ) : {F}_{i} = {G}^{{α}^{i + 1}} for i ∈ [ 2 ( n + 1 ) ] \backslash \{ n + 1 \}$$

2. V←Commit(pp_{VC}, v, r). To commit to vector v=(v₀, . . . , vₙ₋₁) with randomness r, compute

$$V = {F [ : n + 1 ]}^{v \vert \vert r} = {F}_{n}^{r} {\prod }_{i = 0}^{n - 1} {F}_{i}^{{v}_{i}}$$

3. Ω←Open(pp_{VC}, i, v, r). To reveal element v[i], compute

$$Ω = {F}_{2 n - i}^{r} {\prod }_{j = 0 , j \neq i}^{n - 1} \prod Fn + j - {iv}_{j} = {( \frac{v}{{F}_{i}^{{v}_{i}}} )}^{{α}^{n + 1 - i}}$$

4. b←VerOpen(pp_{VC}, V, i, v, Ω). To verify if v opens V at index i, check if e(V, Fₙ₋ᵢ)=e(Ω, G)e(F₀, Fₙ)^{v}. If yes, then output 1. Otherwise output 0. The method calls Ω the opening proof of triple index, value and commitment (i, v, V).

Both same and cross aggregation rely on computing a product of the proofs of individual openings raised to some exponent. To preserve the binding property after aggregation, this exponent is computed as a hash of the vector commitments, the indices being opened and the values at these indices. In the following, S⊆[n] denotes the subset of indices the method is aggregating across.
5. \hat{Ω}←AggregateSame(pp_{VC}, V, S, v[S], {Ωᵢ}_{i∈S}). Outputs

\hat{Ω}=Π_{i∈S}Ωᵢ^{t}^{ᵢ}

where Ωᵢ is the opening of V at index i and tᵢ=h(i, V, S, {vᵢ}_{i∈S}).
6. b←VerOpenSame(pp_{VC}, V, S, v[S], \hat{Ω}). To verify if vᵢ opens V at index i for all i∈S, check if

e(V, Π_{i∈S}Fₙ₋ᵢ^{t}^{ᵢ})=e(\hat{Ω}, G)e(F₀, Fₙ)^{Σ}^{_{i∈S}}^{v}^{ᵢ}^{t}^{ᵢ}.

where tᵢ is as before. If equal, output 1. Otherwise output 0.
7. Ω←AggregateAcross(pp_{VC}, {Vⱼ, Sⱼ, vⱼ[Sⱼ], \hat{Ω}}_{j∈[k]}). Outputs

Ω=Π_{j∈[k]}\hat{Ω}ⱼ^{t}^{_{j′}}

where \hat{Ω}ⱼ is the aggregated opening from AggregateSame and

t_{j′}=h′(j, {Vⱼ, Sⱼ, vⱼ[Sⱼ]}_{j∈[k]}).
8. b←VerOpenAcross(pp_{VC}, {Vⱼ, Sⱼ, vⱼ[Sⱼ]}_{j∈[k]}, Ω). To verify if the vⱼ[Sⱼ] open Vⱼ at positions Sⱼ, check if

Π_{i∈[k]}e(Vⱼ,Π_{i∈S}Fₙ₋ᵢ^{t}^{_{j,i}})^{t}^{_{j′}}=e(Ω, G)e(F₀, Fₙ)^{Σ}^{_{j∈[k],i∈S}}ⱼ^{v[i]t}^{_{j,i}}^{t}^{_{j′}}

where Ω is the cross aggregation opening,

t_{j′}=h′(j, {Vⱼ, Sⱼ, vⱼ[Sⱼ]}_{j∈[k]}) and t_{j,i}=h(i, Vⱼ, Sⱼ, vⱼ[Sⱼ]).

If the equality holds, then output 1. Otherwise output 0.

### Opening Equality Argument

Let F=(F₀, . . . , Fₙ) be the n+1 first generators from the public parameters of the hiding vector commitments. An opening equality argument for our instantiation should prove in zero-knowledge that two Pointproofs vector commitments V and W open to the same value v at indices i and j respectively. This corresponds to proving the following equalities in zero-knowledge:

e(V, Fₙ₋ᵢ)=e(Ω_{V}, G)e(F₀, Fₙ)^{v}

e(W, Fₙ₋ⱼ)=e(Ω_{W}, G)e(F₀, Fₙ)^{v}

Where Ω_{V} and Ω_{W} are the opening proofs for triples (i, v, V) and (j, v, W) respectively. Since these equalities involve pairings, the method can use a zero-knowledge argument tailored for Pointproofs that circumvents zero-knowledge verification of pairing equalities. Namely, the prover need not prove knowledge of Ω_{V} and Ω_{W} to convince the verifier that V and W open to the same value v, at indices i and j.

Let \hat{V} and Ŵ be Pointproofs vector commitments that commit to the same value u at indices i and j. This means that there exists unique (\hat{Ω}_{V}, \hat{Ω}_{W})∈ [symbol] × [symbol] such that:

e(\hat{V}, Fₙ₋ᵢ)=e(\hat{Ω}_{V}, G)e(F₀, Fₙ)^{u}

e(Ŵ,Fₙ₋ⱼ)=e(\hat{Ω}_{W}, G)e(F₀, Fₙ)^{u}

By the additive homomorphism of Pointproofs, V\hat{V}^{x} and WŴ^{x} are commitments that open to the same value c=v+xu at indices i and j, for any x∈Zₚ. This can be expressed as follows.

e(V\hat{V}^{x}, Fₙ₋ᵢ)=e(Ω_{V}\hat{Ω}_{V}^{x}, G)e(F₀, Fₙ)^{c}

e(WŴ^{x},Fₙ₋ⱼ)=e(Ω_{W}\hat{Ω}_{W}^{x}, G)e(F₀, Fₙ)^{c}

Thanks to cross-commitment aggregation in Pointproofs, the method can aggregate these equalities into one:

$$e ( {( V {\hat{V}}^{x} )}^{{t}_{0}} , {F}_{n - i} ) e ( {( W {\hat{W}}^{x} )}^{{t}_{1}} , {F}_{n - j} ) = e ( Ω , G ) {e ( {F}_{0} , {F}_{n} )}^{( {t}_{0} + {t}_{1} ) c} \qquad ( 1 )$$

where tₖ=h(k, V\hat{V}^{x}, WŴ^{x}, i, j, c), k∈{0,1} and

Ω=(Ω_{V}\hat{Ω}_{V}^{x})^{t}^{₀}(Ω_{W}\hat{Ω}_{W}^{x})^{t}^{₁}.

The idea of the argument is that if u is random, then (c, (2) can be sent in the clear, enabling the verifier to check Equation 1 directly.

Now by the soundness of the aggregation of Pointproofs, c opens V\hat{V}^{x} and WŴ^{x} at indices i and j respectively. Let v denote the i^{th} element of the vector committed in V and w the j^{th} element of the vector committed in W. Let \hat{v} denote the i^{th} element of the vector committed in \hat{V} and ŵ the j^{th} element of the vector committed in Ŵ. By the binding property of Pointproofs, c=v+x\hat{v}=w+xŵ. If x is random (in particular, if x is computed as h(V, W, \hat{V}, Ŵ)), then the Shwartz-Zippel lemma guarantees that v=w and \hat{v}=ŵ with all but negligible probability 1/p.

Zero-knowledge, on the other hand, follows from the fact that a simulator with knowledge of the trapdoor α of Pointproofs and control over a random oracle, can randomly select c, Ŵ and \hat{V}, and successfully find Ω that satisfies Equation 1.

### Sum Argument

To instantiate a sum argument over vector commitments for our PoL, it is sufficient to devise a zero-knowledge argument for relation

$$x = V ; w = ( v , r ) ∈ {ℤ}_{p}^{n} \times {ℤ}_{p} : V = {F}^{r} {G}^{v} ∧ v [ n - 1 ] = {\sum }_{i = 0}^{n - 2} v [ i ] .$$

Where G=(G₀, . . . , Gₙ₋₁) and F are n+1 random generators of [symbol] . V here is a hiding Pedersen commitment and not a Pointproof one. It is noted though that a Pointproofs hiding vector commitment is an instantiation of a Pedersen commitment with G=(F₀, . . . , Fₙ₋₁)=(G^{α}, . . . , G^{α}^{ⁿ}) a and F=Fₙ=G^{α}^{ⁿ⁺¹}.

The sum argument can be also given by functional commitment (FC) schemes for linear functions.

Observe that v[n−1]=Σᵢ₌₀ⁿ⁻²v[i] is equivalent to the inner product v·b being zero, where b is the n-dimensional vector (1, . . . ,1,−1). The method can leverage an inner product argument (IPA) to realize the sum argument. Inner product arguments, however, do not satisfy zero-knowledge if the IPA's prover is called on vectors v and b. The method can prevent leakage by blinding vector v and then running the IPA's prover on the blinded vector.

Specifically, the sum argument prover selects a random vector w of n elements and computes a Pedersen commitment W=F^{r′}G^{w} and the inner product c=w·b. Then it computes the challenge x as the hash of (c, V, W). Let a be the vector defined as v+xw. If v·b=0, then a·b=cx. Thanks to Schwartz-Zippel lemma, if a·b=cx, then v·b=0 with all but negligible probability 1/p.

Let H=(H₀, . . . , Hₙ₋₁) be n random generators of [symbol] and let B denote the Pedersen commitment H^{b}.

Now the sum argument prover prepares the inputs for the IPA's prover. This includes computing Pedersen commitment P=G^{a}H^{b}, which can be shown to be equal to F^{ρ}VW^{x}B for ρ=−r−xr′, where r and r′ are the randomness used in the computation of V and W respectively. Once P is computed, the IPA's prover is called to prove that a·b actually equals cx. The verification of the sum argument proceeds with computing the challenge x and then checking the validity of the IPA's proof in relation to P=F^{ρ}VW^{x}B and cx. If the IPA's proof is valid, then the sum argument's verifier accepts.

### Range Proofs

With range proofs, the method can prove that the values committed to in a vector commitment are positive. The range proofs disclosed herein can prevent an increase in the size of the proofs of liability, e.g., prevent the size of a proof of liability from linearly growing with both the arity of the sparse Verkle tree and its depth. In an embodiment, a range proof is introduced that that takes as input a Pedersen-like vector commitment to a vector v=(v₀, . . . , vₙ₋₁)∈ [symbol] ₚⁿ and proves that for all i∈[n], 0≤vᵢ<max. The communication complexity of this proof is O(log(n·max))=O(log(n)+log(max)).

### Range Proofs—Overview

In an embodiment, a range proof proceeds as follows. First, the method uses a standard split-and-fold technique to iteratively reduce the commitment to a vector v=(v₀, . . . , vₙ₋₁) to a commitment to a single value v. By construction

$$v = {\sum }_{i = 0}^{n - 1} {f}_{i} ( {x}_{0} , … , {x}_{log ( n ) - 1} ) {v}_{i} \qquad ( 2 )$$

where (x₀, . . . , x_{log(n)-1}) are the challenge sent during the reduction.

To prove that 0≤v[i]<2^{m}, the method writes vᵢ as Σⱼ₌₀^{m-1}v_{i,j}2^{j} and computes a commitment to v_{i,j}. Next the method proves in zero-knowledge that each v_{i,j} is a bit. What remains is to show that for all i∈[i], (v_{i,j})_{j∈[m]} actually verify vᵢ=Σⱼ₌₀^{m-1}v_{i,j}2^{j}. To this end, the method replaces vᵢ by Σⱼ₌₀^{m-1}v_{i,j}2^{j} in Eq. 2.

To optimize the range proof, an approach is followed that that uses a single inner product argument to show that v_{i,j} are bits and that they satisfy vᵢ=Σⱼ₌₀^{m-1}v_{i,j}2^{j}. Note that thanks to Eq. 2, the method can prove that a committed vector is in the valid range in one go.

The Iterative Reduction. As described, the method can first reduce vector v=(v₀, . . . , vₙ₋₁) to a single value. To this end, the method can use the iterative reduction technique, which includes μ=log(n) iterations, such that at the end of each iteration, the length of v is halved. The reduction concludes by outputting a single value v that is a function of {vᵢ}_{i∈[n]} and a sequence of challenges {xₖ}_{k∈[μ]}. The method denotes this protocol by Rdx=( [symbol] _{Rdx}, [symbol] _{Rdx}).

Let v∈ [symbol] ₚⁿ and μ=log(n). Given a sequence of uniformly random xₖ∈ [symbol] ₚ for k∈[μ−1], the reduction protocol Rdx reduces v to the value

$$v = {\sum }_{i = 0}^{n - 1} {v}_{i} ( {\prod }_{k = 0}^{μ - 1} {x}_{k}^{Bits ( i ) [ k ]} ) . \qquad ( 3 )$$

where Bits (i)=(b₀, b₁, . . . , b_{μ-1}) is the bit representation of i and b₀ is the least significant bit. Since v is reduced to a single value v which can be described using a closed-form function (Equation 3), the prover can prove statements about v using v instead.

The Range Proof. A goal can be to prove that the vector v committed in V =F^{r}Πᵢ₌₀ⁿ⁻¹Gᵢ^{v[i]} verifies the following: ∀i ∈[n]:0≤v[i]<max. Assume that max=2^{m}. Proving that 0≤v[i]<max is tantamount to showing that v[i]=Σⱼ₌₀^{m-1}2^{j}v_{i,j} for some v_{i,j}∈{0,1}.

The method can start a range proof by executing [symbol] _{Rdx} on v. This yields a value v satisfying Equation 3. Calling [symbol] _{Rdx} on v, however, is not zero knowledge. In particular, if [symbol] _{Rdx} is invoked n times on v, then one could setup a system of n linear equations with n unknowns and easily recover v.

To mitigate this attack, the method can blind v using a random vector w. More precisely, the method can compute a challenge x and run [symbol] _{Rdx} on input vector u=v+xw and commitment U. This returns the proof Γ=(Δ, u) where u=Σᵢ₌₀ⁿ⁻¹u[i]fᵢ, and fᵢ=Πₖ₌₀^{μ-1}xₖ^{Bits(i)[k]}, ∀i∈[n]. Given that u=v+xw and v[i]=Σⱼ₌₀^{m-1}2^{j}v_{i,j}, this equality could be re-written as

$$u = {\sum }_{i = 0}^{n - 1} v [ i ] {f}_{i} + xw [ i ] {f}_{i} = {\sum }_{i = 0}^{n - 1} {\sum }_{j = 0}^{m - 1} {v}_{i , j} {f}_{i} {2}^{j} + {\sum }_{i = 0}^{n - 1} xw [ i ] {f}_{i}$$

Let \hat{v}=(v_{0,0}, . . . , v_{n-1,m-1}∥w), f=(f₀, . . . , fₙ₋₁) and d=(d_{i,j}∥xf) with d_{i,j}=fᵢ2^{j} for all i∈[n] and j∈[m]. Value u can thus be expressed as the inner product of \hat{v} and d, i.e.,

$$u = \hat{v} \cdot d \qquad ( 4 )$$

Proving the correctness of this inner product alone is not sufficient to guarantee that all v's elements are in the correct range. Actually, we must additionally show that the v_{i,j}'s are bits.

Let \hat{v}[:nm]=(v_{0,0}, . . . , v_{n-1,m-1}) and w its bit complement. If \hat{v}[:nm] is indeed comprised of bits, then the following equalities always hold:

$$\begin{matrix}\hat{w} - {1}^{nm} + \hat{v} [ : nm ] = {0}^{nm} & ( 5 ) \\ \hat{v} [ : nm ] ∘ \hat{w} = {0}^{nm} & ( 6 )\end{matrix}$$

The method can express Equations 4, 5 and 6 as the inner product of two vectors that are functions of \hat{v} and Ŵ, and then call the IPA on these two vectors. The following shows how the method can obtain these two vectors. To combine multiple equations into one, the method can take a random linear combination of those constraints as chosen by the verifier. In particular, note that if e=0^{nm}, then ∀y₀=(1, y₀, . . . , y₀^{nm-1}), e·y₀=0. The method can thus re-write Equations 5 and 6 as

$$\begin{matrix}( \hat{w} - {1}^{nm} + \hat{v} [ : nm ] ) \cdot {y}_{0} = 0 & ( 7 ) \\ ( \hat{v} [ : nm ] ∘ \hat{w} ) ∼ {y}_{0} = \hat{v} [ : nm ] \cdot ( \hat{w} ∘ {y}_{0} ) = 0. & ( 8 )\end{matrix}$$

Equalities 4, 7 and 8 can be further combined into a single equality by applying the same technique again using some y₁∈ [symbol] ₚ:

$${y}_{1}^{2} ( \hat{v} \cdot d - u ) + {y}_{1} ( \hat{w} - {1}^{nm} + \hat{v} [ : nm ] ) \cdot {y}_{0} + \hat{v} [ : nm ] \cdot ( \hat{w} ∘ {y}_{0} ) = 0 \qquad ( 9 )$$

Let a′ and b′ be two vectors defined as:

$${a}^{′} = \hat{v} + ( {y}_{1} \vert \vert {0}^{n} ) \\ {b}^{′} = {y}_{1}^{2} d + {y}_{1} ( {y}_{0} \vert \vert {0}^{n} ) + ( ( \hat{w} ∘ {y}_{0} ) \vert \vert {0}^{n} )$$

Accordingly, inner product a′·b′ corresponds to

$${y}_{1}^{2} \hat{v} \cdot d + {y}_{1} \hat{v} \cdot ( {y}_{0} \vert \vert {0}^{n} ) + \hat{v} \cdot ( ( \hat{w} ∘ {y}_{0} ) \vert \vert {0}^{n} ) + {y}_{1}^{2} ( {y}_{1} \vert \vert {0}^{n} ) \cdot d + {y}_{1} ( {y}_{0} \vert \vert {0}^{n} ) \cdot ( {y}_{1} \vert \vert {0}^{n} ) + ( {y}_{1} \vert \vert {0}^{n} ) \cdot ( ( \hat{w} ∘ {y}_{0} ) \vert \vert {0}^{n} ) .$$

Note that if Equation 9 holds, then:

$${a}^{′} \cdot {b}^{′ } = ( {1}^{nm} \cdot {y}_{0} ) {y}_{1}^{3} + ( {1}^{nm} \cdot {y}_{0} + u ) {y}_{1}^{2} + ( {1}^{nm} \cdot d [ : nm ] ) {y}_{1} .$$

Since the IPA is not zero-knowledge, the prover cannot call it with a′ and b′, as this would leak information about \hat{v} and ŵ. Instead, it invokes it with blinded vectors a and b such that the constant term of (a, b) is actually (a′, b′). Thus, proving that the inner product (a, b) is computed correctly implies that (a′, b′) is also correct. The method can compute a and b as follows.

$$a = {a}^{′} + zs = ( \hat{v} + zs ) + ( {y}_{1} \vert \vert {0}^{n} ) \\ b = {b}^{′} + z ( {y}_{0} ∘ t ) \vert \vert {0}^{n} = {y}_{1}^{2} d + {y}_{1} ( {y}_{0} \vert \vert {0}^{n} ) + ( ( \hat{w} - zt ) ∘ {y}_{0} ) \vert \vert {0}^{n}$$

where z is a random element in [symbol] ₚ and s and t are two random vectors of length nm+n and nm respectively.

The following shows how to compute y₀, y₁, z in a way that guarantees the soundness of the range proof. Let H=(H₀, . . . , Hₙ₍ₘ₊₁₎₋₁) and F=(F₀, . . . , Fₙ₍ₘ₊₁₎₋₁) be two vectors of n(m+1) generators of [symbol] . The prover first computes Q=F^{v}H^{\hat{v}}F[:nm]^{ŵ} a commitment to vectors \hat{v} and ŵ, and a commitment R=F^{η}H^{s}F[:nm]^{t} to vectors s and t. It then computes y₀ and y₁ as h(U, Q, R, 0) and h(U, Q, R, 1) respectively. Note that

$$a \cdot b = {c}_{0} + {c}_{a} z + {c}_{2} {z}^{2} , where \\ {c}_{0} = {a}^{′} \cdot {b}^{′} ; {c}_{1} = {a}^{′} [ : nm ] \cdot ( {y}_{0} ∘ t ) + s \cdot {b}^{′} \\ {c}_{2} = s [ : nm ] \cdot ( {y}_{0} ∘ t )$$

Correspondingly, the prover computes commitments C₁=G^{c}^{₁}H^{τ}^{₁} and C₂=G^{c}^{₂}H^{τ}^{₂} for random τ₁ and τ₂ (line 32), and then sets z to h (U, Q, R, C₁, C₂).

The next step of the prover is to compute for the IPA the commitment of vectors a and b as a function of the commitments Q and R. Note that Q is a commitment to vectors \hat{v} and \hat{v}∘y₀ using generators H and

$${F}^{′} = ( {F}_{0} , {F}_{1}^{{y}_{0}^{- 1}} , … , {F}_{n ( m + 1 ) - 1}^{- ( n ( m + 1 ) - 1 )} ) .$$

Now to produce a commitment P for vectors a and b with generators H and F′, the prover computes ρ=−v−ηz and sets P to F^{ρ}QR^{z}H[:nm]^{y}^{₁}F′^{y}^{₁}^{2 d}F [:nm]^{y}^{₁}.

The prover concludes by calling [symbol] _{IPA} on P and c=a·b.

To verify the correctness, [symbol] proceeds as follows: [leftmargin=*]
1. Run the Rdx verifier to check the correctness of u relative to commitment U and obtain the sequence of challenges x. If the Rdx verifier rejects, then reject.
2. Compute d as a function of challenges x and x.
3. Compute c₀=(1^{nm}·y₀)y₁+(1^{nm}·y₀+u)y₁2+(1^{nm}·d [:nm])y₁³.
4. Check that c is well formed by verifying that C₁^{Z}C₂^{Z}^{²}G^{c}^{₀}=G^{c}^{₀}H^{τ}. If the equation does not hold, reject.
5. Compute commitment P as a function of commitments Q and R and run the IPA's verifier on P and c, and with generators H and F′. If the IPA's verifier accepts, then accept.

Verkle tree topology. In an aspect, the proofs associated to each vertex are made with respect to the values it commits to, for which there exist descendant vertices. In an embodiment, the method can optimize the topology of the Verkle tree by making the degree (or fan-out) of each vertex be a power of two minus 1 (e.g 2³−1 or 2⁴−1). Therefore, when constructing the vector an inner product argument works on, it becomes a power of two because the last element in the vector is the sum of the previous elements.

In an embodiment, a PoL scheme can implement following operations in its algorithm.
(PD, SD)←$ Setup(1^{κ}, DB) is a probabilistic polynomial-time algorithm executed by prover P that takes as input a security parameter K and a database DB={(idᵤ, [symbol] ᵤ) [symbol] , comprising of an identifier-liability pair for each user u∈ [symbol] . It outputs public data PD and secret data SD only known to P.
(Π, L)←ProveTot(DB,SD) is a polynomial-time algorithm executed by P at the behest of an authorized auditor if the scheme calls for one. It takes as input the database DB and P′s secret data SD. It outputs the total liability L and associated proof Π.
b←VerifyTot(PD, L, Π). Given the total liabilities L and its associated proof Π, an authorized auditor can inspect the validity of L according to the public data PD. The polynomial-time algorithm returns 1 if the verification succeeds and 0 otherwise.
π←Prove(DB,SD, id) is a polynomial time algorithm executed by P. It takes as input the database DB, P's secret data SD, and a user ID id. It outputs a proof π indicating the inclusion of P's liabilities to the user in the total liabilities.
b←Verify(PD, id, [symbol] , π) is a polynomial-time algorithm executed by the user. It takes as input the public data PD, the user's ID id, P′s liabilities to the user [symbol] , and the associated proof of inclusion π. It returns 1 if verification succeeds and 0 otherwise.

In one or more embodiments, a fully-private decentralized PoL scheme is provided with short proofs that leaks only the size of the user universe. Such scheme can be achieved through the use of sparse summation Verkle trees together with tailor-made zero-knowledge arguments that enable users to verify the inclusion of their individual liabilities without compromising their privacy or the privacy of the party holding the liabilities.

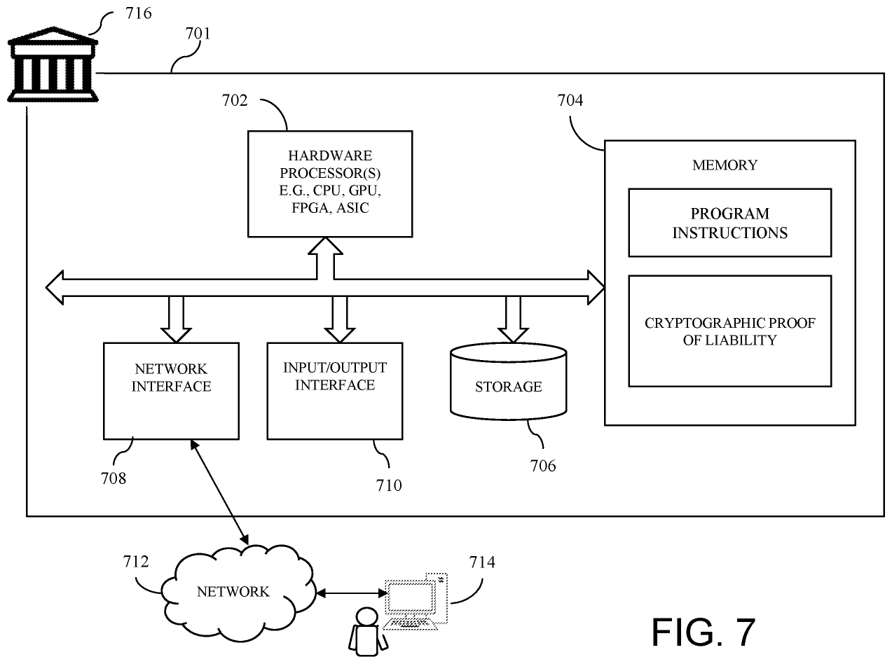

FIG. 7 is a diagram showing components of a system in one embodiment that can provide cryptographic proof of liabilities scheme. In an embodiment, the components shown at 701 can be part of a computing environment, e.g., described with reference to FIG. 1 above. One or more hardware processors 702 such as a central processing unit (CPU), a graphic process unit (GPU), and/or a Field Programmable Gate Array (FPGA), an application specific integrated circuit (ASIC), and/or another processor, may be coupled with a memory device 704, and cryptographic proof of liabilities scheme. A memory device 704 may include random access memory (RAM), read-only memory (ROM) or another memory device, and may store data and/or processor instructions for implementing various functionalities associated with the methods and/or systems described herein. One or more processors 702 may execute computer instructions stored in memory 704 or received from another computer device or medium. A memory device 704 may, for example, store instructions and/or data for functioning of one or more hardware processors 702, and may include an operating system and other program of instructions and/or data. For instance, at least one hardware processor 702 may generate a tree data structure having a root node, internal nodes and leaf nodes, where the tree data structure is a sparse n-ary tree having depth d. At least one hardware processor 702 may also, for each user in a set of users, map a liability to a user to a leaf node of the tree data structure, where each internal node of the tree data structure contains vector commitments to its child nodes and the root node contains a commitment to a sum of all leaf nodes in the tree. At least one hardware processor 702 may also receive a query from a requesting device 714 associated with a user in the set of users, that a liability to the user is included in a total liability of a prover 716. At least one hardware processor 702 may also, responsive to receiving the query, generate an authentication path along the tree data structure and a plurality of proofs that prove that sums of terms in vectors along the authentication path are correct, that each entry in the vectors along the authentication path is positive, and that a sum associated with a vector in each node along the authentication path is an entry in a parent node's vector. At least one hardware processor 702 may also provide the authentication path and the plurality of proofs over a communications network 712 to the requesting device 714. In one aspect, data used by the system components can be stored in a storage device 706 and/or received via a network interface 708 from a remote device, and may be temporarily loaded into a memory device 704 for providing cryptographic proof of liabilities scheme. One or more hardware processors 702 may be coupled with interface devices such as a network interface 708 for communicating with remote systems, for example, via a network, and an input/output interface 710 for communicating with input and/or output devices such as a keyboard, mouse, display, and/or others.

In an embodiment, components shown at 701 can be associated with a prover 716 or an entity providing proof of liabilities, for example, to a verifier device 714, e.g., via a network 708. For example, a prover 716 can be associated with an entity or institution providing proof of liabilities to a verifier device 714, which can be a device of a customer who requests proof of liabilities for proving that the verifier's liability is included in the total liabilities of the entity. Proof of liabilities provision can be instantiated by using a blockchain. As another example of a use case, a prover 716 can be associated with voting system where the voting system provides proof of liabilities to a verifier device 714, which can be a device of a voter, requesting proof that the voter's vote is counted in the total number of votes. Yet another example of a use case can be one that is applicable in publishing information about a disease outbreak. For example, a prover can provide a proof that all those infected (e.g., verifiers) were counted in the total, without jeopardizing leakage of information pertaining to both the prover and verifiers. In all the example cases, proof of liabilities method and system disclosed herein can preserve secrecy of information for both parties (prover and verifier (also referred to as user)), provide security during transmission via communication network, provide computer storage efficiency and processing.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”. “including”, and/or “having.” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
generating a tree data structure having a root node, internal nodes and leaf nodes, wherein the tree data structure is a sparse n-ary tree having depth d;
for each user in a set of users, mapping a liability to a user to a leaf node of the tree data structure, wherein each internal node of the tree data structure contains vector commitments to its child nodes and the root node contains a commitment to a sum of all leaf nodes in the tree;
receiving a query from a requesting device associated with a user in the set of users, that a liability to the user is included in a total liability of a prover;
responsive to receiving the query, generating an authentication path along the tree data structure and a plurality of proofs that prove that sums of terms in vectors along the authentication path are correct, that each entry in the vectors along the authentication path is positive, and that a sum associated with a vector in each node along the authentication path is an entry in a parent node's vector; and
providing the authentication path and the plurality of proofs over a communications network to the requesting device.

2. The computer-implemented method of claim 1, wherein at each internal node at depth d−1, V is a vector commitment of liabilities of the leaf nodes and a sum of the liabilities.

3. The computer-implemented method of claim 1, wherein each internal node at depth d−2 and lower includes two vector commitments <V, W>.

4. The computer-implemented method of claim 3, wherein at each internal node at depth i∈[d−2], V commits to (v₀, . . . , vₙ) wherein for all j∈[n], vⱼ is a sum of values committed in a V component of a j^{th} child node, and vₙ is a sum of values (v₀, . . . , vₙ₋₁).

5. The computer-implemented method of claim 3, wherein W commits to (w₀, . . . , wₙ₋₁) wherein for all j∈[n], wⱼ is a hash of a content of a j^{th} child node.

6. The computer-implemented method of claim 1, wherein the root node commits to vector (v₀, . . . , vₙ), vₙ being a sum of all values stored in non-empty leaf nodes of the tree data structure.

7. The computer-implemented method of claim 1, further comprising batching the plurality of proofs along the authentication path.

8. A computer program product comprising a computer readable storage medium having program instructions embodied therewith, the program instructions readable by a device to cause the device to:
generate a tree data structure having a root node, internal nodes and leaf nodes, wherein the tree data structure is a sparse n-ary tree having depth d;
for each user in a set of users, map a liability to a user to a leaf node of the tree data structure, wherein each internal node of the tree data structure contains vector commitments to its child nodes and the root node contains a commitment to a sum of all leaf nodes in the tree;
receive a query from a requesting device associated with a user in the set of users, that a liability to the user is included in a total liability of a prover;
responsive to receiving the query, generate an authentication path along the tree data structure and a plurality of proofs that prove that sums of terms in vectors along the authentication path are correct, that each entry in the vectors along the authentication path is positive, and that a sum associated with a vector in each node along the authentication path is an entry in a parent node's vector; and
provide the authentication path and the plurality of proofs over a communications network to the requesting device.

9. The computer program product of claim 8, wherein at each internal node at depth d−1, V is a vector commitment of liabilities of the leaf nodes and a sum of the liabilities.

10. The computer program product of claim 8, wherein each internal node at depth d−2 and lower includes two vector commitments <V, W>.

11. The computer program product of claim 10, wherein at each internal node at depth i∈[d−2], V commits to (v₀, . . . , vₙ) wherein for all j∈[n], vⱼ is a sum of values committed in a V component of a j^{th} child node, and vₙ is a sum of values (v₀, . . . , vₙ₋₁).

12. The computer program product of claim 10, wherein W commits to (w₀, . . . , wₙ₋₁) wherein for all j∈[n], wⱼ is a hash of a content of a j^{th} child node.

13. The computer program product of claim 8, wherein the root node commits to vector (v₀, . . . , vₙ), vₙ being a sum of all values stored in non-empty leaf nodes of the tree data structure.

14. The computer program product of claim 8, wherein the device is further caused to batch the plurality of proofs along the authentication path.

15. A system comprising:
at least one processor; and
a memory device coupled to the at least one processor;
the at least one processor configured to at least:
generate a tree data structure having a root node, internal nodes and leaf nodes, wherein the tree data structure is a sparse n-ary tree having depth d;
for each user in a set of users, map a liability to a user to a leaf node of the tree data structure, wherein each internal node of the tree data structure contains vector commitments to its child nodes and the root node contains a commitment to a sum of all leaf nodes in the tree;
receive a query from a requesting device associated with a user in the set of users, that a liability to the user is included in a total liability of a prover;
responsive to receiving the query, generate an authentication path along the tree data structure and a plurality of proofs that prove that sums of terms in vectors along the authentication path are correct, that each entry in the vectors along the authentication path is positive, and that a sum associated with a vector in each node along the authentication path is an entry in a parent node's vector; and
provide the authentication path and the plurality of proofs over a communications network to the requesting device.

16. The system of claim 15, wherein at each internal node at depth d−1, Vis a vector commitment of liabilities of the leaf nodes and a sum of the liabilities.

17. The system of claim 15, wherein each internal node at depth d−2 and lower includes two vector commitments <V, W>.

18. The system of claim 17, wherein at each internal node at depth i∈[d−2], V commits to (v₀, . . . ,vₙ) wherein for all j∈[n], vⱼ is a sum of values committed in a V component of a j^{th} child node, and vₙ is a sum of values (v₀, . . . , vₙ₋₁).

19. The system of claim 17, wherein W commits to (w₀, . . . , wₙ₋₁) wherein for all j∈[n], wⱼ is a hash of a content of a j^{th} child node.

20. The system of claim 15, wherein the root node commits to vector (v₀, . . . , vₙ), vₙ being a sum of all values stored in non-empty leaf nodes of the tree data structure.
